(19) United States
(12) Patent Application Publication
(10) Pub. No.: US 2010/0011380 A1
(43) Pub. Date: Jan. 14, 2010

(54) SYSTEM AND METHOD FOR REPLACING DEVICE DRIVERS

(75) Inventors: Zak Dechovich, Tel Aviv (IL); Yossi Koren, Jerusalem (IL)

Correspondence Address: Professional Patent Solutions, P.O. BOX 654, HERZELIYA PITUACH, 46105, IL

(73) Assignee: REIMAGE, Ramat Gan (IL)

(21) Appl. No.: 12/170,546

(22) Filed: Jul. 10, 2008

(51) Int. Cl. G06F 9/44; G06F 9/00

(52) U.S. Cl. 719/327; 713/100

(57) ABSTRACT

Disclosed is a method system and application for replacing device drivers on an operating system associated with a computing platform. According to some embodiments of the present invention, an operating system may be configured to use a set of device drivers corresponding to the hardware installed on the computing platform. In the event of a change of hardware, the installed device drivers need to be adapted to the new devices.

### FIELD OF THE INVENTION

The present invention relates generally to the field of computing. More specifically, the present invention relates to a method and system for replacing device drivers on an operating system.

### BACKGROUND

In recent years the personal computer system is undergoing an increasingly rapid evolution in speed, processing power and capacity and available features. As a consequence, users who desire to maintain a “state of the art” capacity must periodically upgrade the hardware capacity of their computer. Users may also be forced to have key hardware components replaced due to malfunction.

When a user upgrades to a new hardware platform a problem is created regarding the user's existing operating system. Typically, the new hardware platform requires new device drivers, for different peripheral devices. Consequently, the mere connecting of the old hard disk to a replacement computer system will usually not result in a functioning system, requiring time-consuming operations such as manual installation of drivers, and may even require reinstallation of the operating system. Since these operations severely limit the computer's usability, they severely diminish the user's efficiency until they are resolved.

It would be useful, therefore, to have a method and system for replacing device drivers on an operating system.

### SUMMARY OF THE INVENTION

The present invention is a method system and application for replacing device drivers on an operating system associated with a computing platform. According to some embodiments of the present invention, an operating system may be configured to use a set of device drivers corresponding to the hardware installed on the computing platform. In the event of a change of hardware, the installed device drivers need to be adapted to the new devices.

According to some embodiments of the present invention, a hardware scanning module may identify devices associated with the computing platform, and may generate a list of device identifiers. According to some embodiments of the present invention, a comparison module may compare device identifiers found by the hardware scanning module with identifiers derived from image blocks of drivers installed with an operating system associated with the computing platform. According to further embodiments of the present invention, the comparison module may compare driver components (i.e. device identifiers) which exist on a client computer (e.g. in the registry) with a reference list of driver components that may be stored on a client computer in accordance with the client's operating system and computing platform. According to some embodiments of the present invention, a driver image block may include one or more files and/or a set of operating system settings (e.g. Windows registry keys) associated with the driver. According to some embodiments of the present invention, a driver replacement module may replace or modify an installed driver image block associated with a device identifier not correlated with the generated list of device identifiers.

According to some embodiments of the present invention, the driver replacement system may include an application-specific operating system (“ASOS”), adapted to load said system independently of the operating system associated to the computing platform. According to further embodiments of the present invention, the ASOS may be installed on removable media, such as but not limited to: USB storage, CD-ROM, DVD-ROM, or any other storage media known today or to be devised in the future.

According to some embodiments of the present invention, the driver replacement module may be adapted to modify operating system settings (such as the Windows' registry) as part of the driver replacement or modification process.

According to some embodiments of the present invention, the driver replacement module may load replacement driver image blocks from a hard disk drive associated with the computing system. According to alternative embodiments of the present invention, replacement driver image blocks may be stored on removable media, such as but not limited to: USB storage, cd-rom, dvd-rom, or any other storage media known today or to be devised in the future. According to other embodiments of the present invention, replacement driver image blocks may be stored on a driver image repository server.

Various methods, techniques and technologies for generating, storing and using software component image blocks to achieve software system remediation are taught in PCT application PCT/IL 2007/000677, which PCT application is co-owned by the assignee of the present application. PCT application PCT/IL 2007/000677 is hereby incorporated by reference in its entirety.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1A is a block diagram illustrating the main components of an exemplary driver replacement system including an image repository server in accordance with some embodiments of the present invention;

FIG. 1B is a block diagram illustrating the functional building blocks of a driver replacement system including an image repository server in accordance with some embodiments of the present invention;

FIG. 2A is a flowchart illustrating an exemplary method by which a driver replacement system replaces drivers on a computer from the viewpoint of a driver image repository server;

FIG. 2B is a flowchart illustrating an exemplary method by which a driver replacement system replaces drivers on a computer from the viewpoint of a driver image repository server;

FIG. 2C is a flowchart illustrating an exemplary method by which a driver replacement system replaces drivers on a computer from the viewpoint of a driver image repository server;

FIG. 3A is a block diagram illustrating the functional building blocks of a driver replacement system in accordance with some embodiments of the present invention;

FIG. 3B is a block diagram illustrating the functional building blocks of a driver replacement system in accordance with some embodiments of the present invention;

FIG. 4A is a flowchart illustrating an exemplary method by which a driver replacement system replaces drivers on a computer;

FIG. 4B is a flowchart illustrating an exemplary method by which a driver replacement system replaces drivers on a computer; and

FIG. 4C is a flowchart illustrating an exemplary method by which a driver replacement system replaces drivers on a computer.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

Unless specifically stated otherwise, as apparent from the following discussions, it is appreciated that throughout the specification discussions utilizing terms such as “processing”, “computing”, “calculating”, “determining”, or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

Embodiments of the present invention may include apparatuses for performing the operations herein. This apparatus may be specially constructed for the desired purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs) electrically programmable read-only memories (EPROMs), electrically erasable and programmable read only memories (EEPROMs), magnetic or optical cards, or any other type of media suitable for storing electronic instructions, and capable of being coupled to a computer system bus.

The processes and displays presented herein are not inherently related to any particular computer or other apparatus. Various general purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the inventions as described herein.

The present invention is a method system and application for replacing device drivers on an operating system associated with a computing platform. According to some embodiments of the present invention, an operating system may be configured to use a set of device drivers corresponding to the hardware installed on the computing platform. In the event of a change of hardware, the installed device drivers need to be adapted to the new devices.

According to some embodiments of the present invention, a hardware scanning module may identify devices associated with the computing platform, and may generate a list of device identifiers. According to some embodiments of the present invention, a comparison module may compare device identifiers found by the hardware scanning module with identifiers derived from images of drivers installed with an operating system associated with the computing platform. According to further embodiments of the present invention, the comparison module may compare driver components (i.e. device identifiers) which exist on a client computer (e.g. in the registry) with a reference list of driver components that may be stored on a client computer in accordance with the client's operating system and computing platform. According to some embodiments of the present invention, a driver image may include one or more files and/or a set of operating system settings (e.g. Windows registry keys) associated with the driver. According to some embodiments of the present invention, a driver replacement module may replace or modify an installed driver image associated with a device identifier not correlated with the generated list of device identifiers.

According to some embodiments of the present invention, the driver replacement system may include an application-specific operating system (“ASOS”), adapted to load the said system independently of the operating system associated to the computing platform. According to further embodiments of the present invention, the ASOS may be installed on removable media, such as but not limited to: USB storage, CD-ROM, DVD-ROM, or any other storage media known today or to be devised in the future.

According to some embodiments of the present invention, the driver replacement module may be able to modify operating system settings (such as the Windows' registry) as part of the driver replacement process.

According to some embodiments of the present invention, the driver replacement module may load replacement driver images from a hard disk drive associated with the computing system. According to alternative embodiments of the present invention, replacement driver images may be stored on removable media, such as but not limited to: USB storage, cd-rom, dvd-rom, or any other storage media known today or to be devised in the future. According to other embodiments of the present invention, replacement driver images may be stored on a repository server.

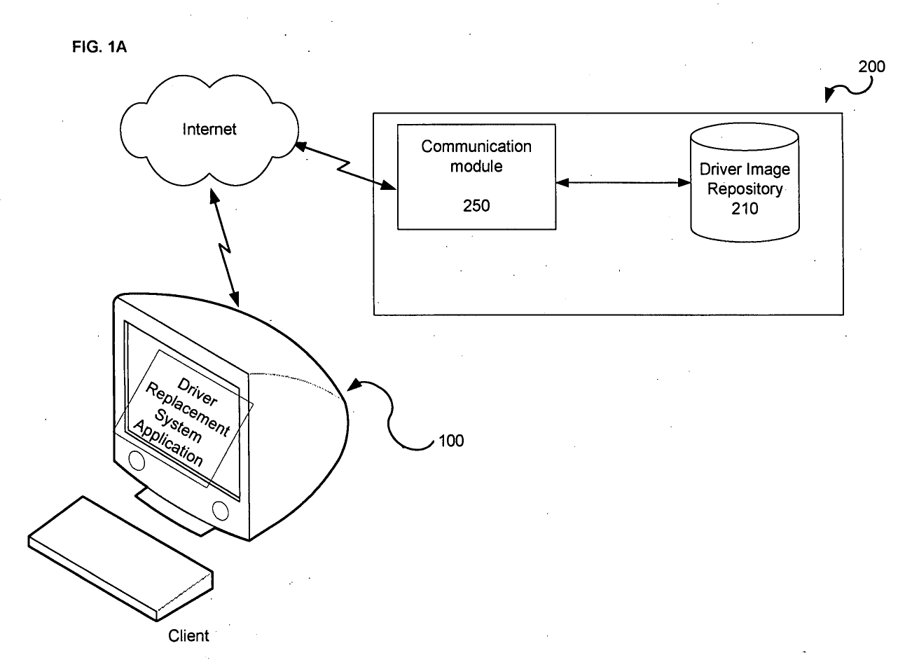

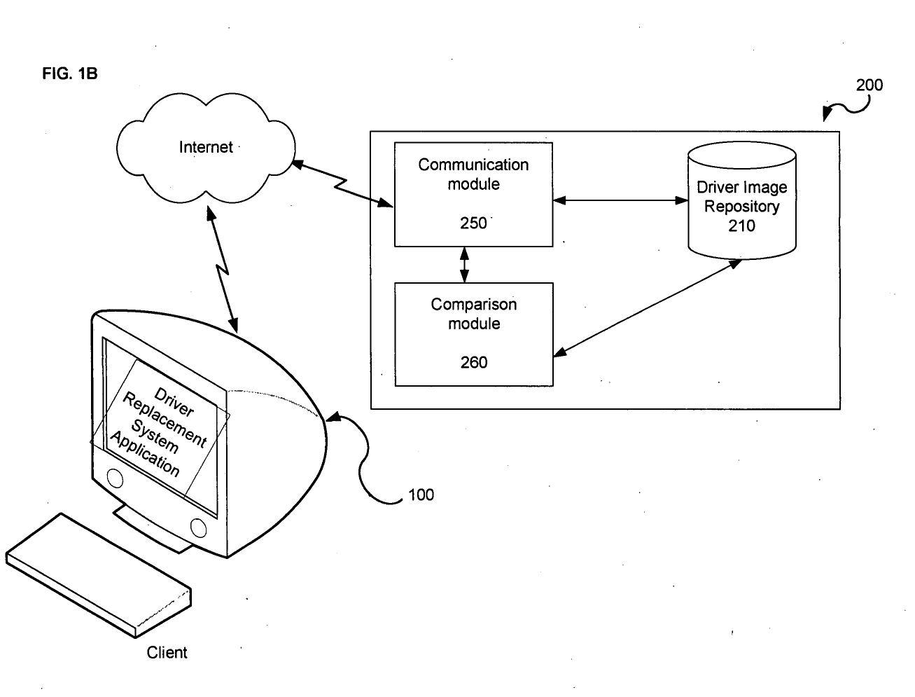

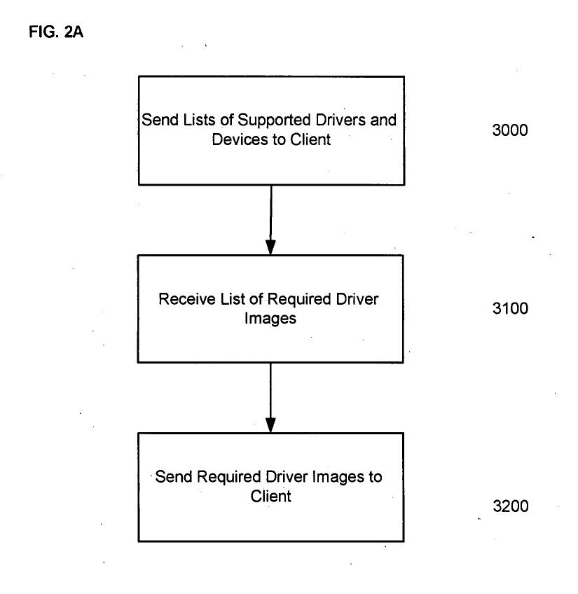

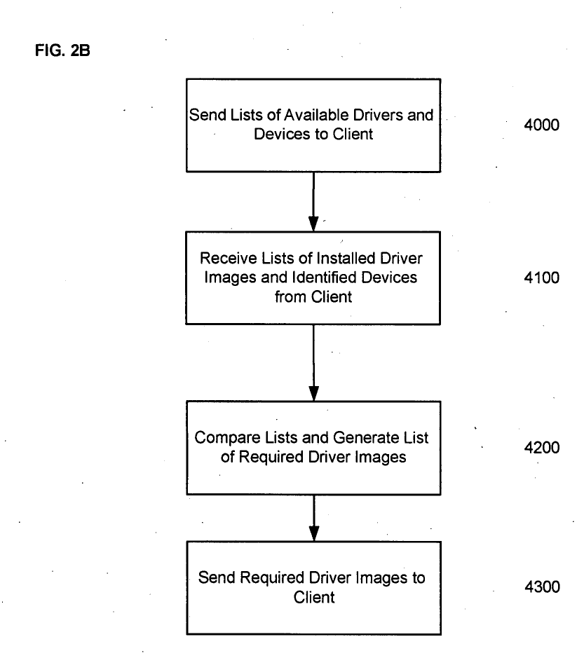

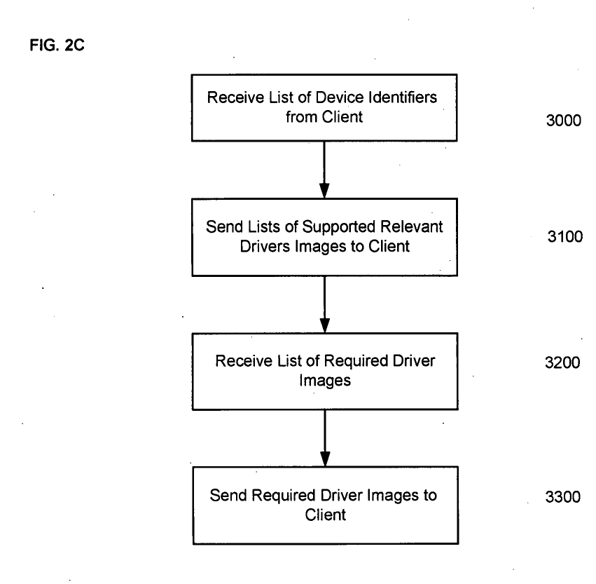

Reference is now made to FIG. 1A, which is a block diagram illustrating the functional building blocks of a driver replacement system including an image repository server in accordance with some embodiments of the present invention, and to FIG. 2A, which is a flowchart illustrating an exemplary method by which a driver replacement system may replace drivers on a computer from the viewpoint of a driver image repository server. According to some embodiments of the present invention, a computer running the driver replacement system (“client computer”) 100 may connect to a repository server 200 via communication module 250, and may receive lists of available drivers and identifiable devices (step 3000). The client 100 may also scan the installed hardware and software, generate a list of required driver images, and sends the list to the server (step 3100). The server may then send the required driver images to the client (step 3200), where the driver images may be used by an application running on the client to install one or more new drivers on the client.

Reference is now made to FIG. 1B, which is a block diagram illustrating the functional building blocks of a driver replacement system including an image repository server 200 in accordance with some embodiments of the present invention, and to FIG. 2B, which is a flowchart illustrating an exemplary method by which a driver replacement system may replace drivers on a computer from the viewpoint of a driver image repository server 200. According to some embodiments of the present invention, a computer running the driver replacement system (“client computer”) 100 may connect to a repository server 200 via the communication module 250, and may receive a list of available drivers and identifiable devices (step 4000). The client 100 then scans the installed hardware and software, and sends the server lists of identified driver images and identified devices installed on it (step 4100). The lists are then forwarded to the comparison module 260, which compares the received lists and generates a list of required driver images (step 4200). The server then sends the required driver images to the client (step 4300).

Reference is now made to FIG. 1A, which is a block diagram illustrating the functional building blocks of a driver replacement system including an image repository server in accordance with some embodiments of the present invention, and to FIG. 2C, which is a flowchart illustrating an exemplary method by which a driver replacement system may replace drivers on a computer from the viewpoint of a driver image repository server. According to some embodiments of the present invention, a computer running the driver replacement system (“client computer”) 100 may connect to a repository server 200 via communication module 250, and may send a list of identifiers for devices it has detected (step 3000). The server then sends to the client lists of available drivers and identifiable devices (step 3100). The client 100 may also scan the installed hardware and software, generate a list of required driver images, and sends the list to the server (step 3200). The server may then send the required driver images to the client (step 3300), where the driver images may be used by an application running on the client to install one or more new drivers on the client.

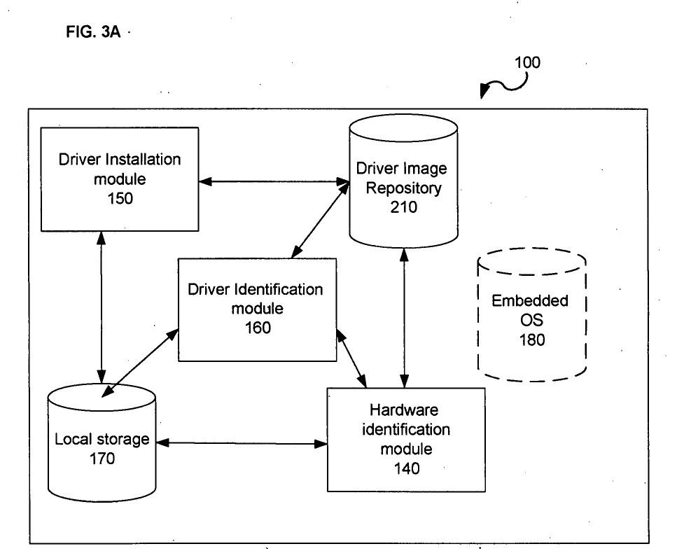

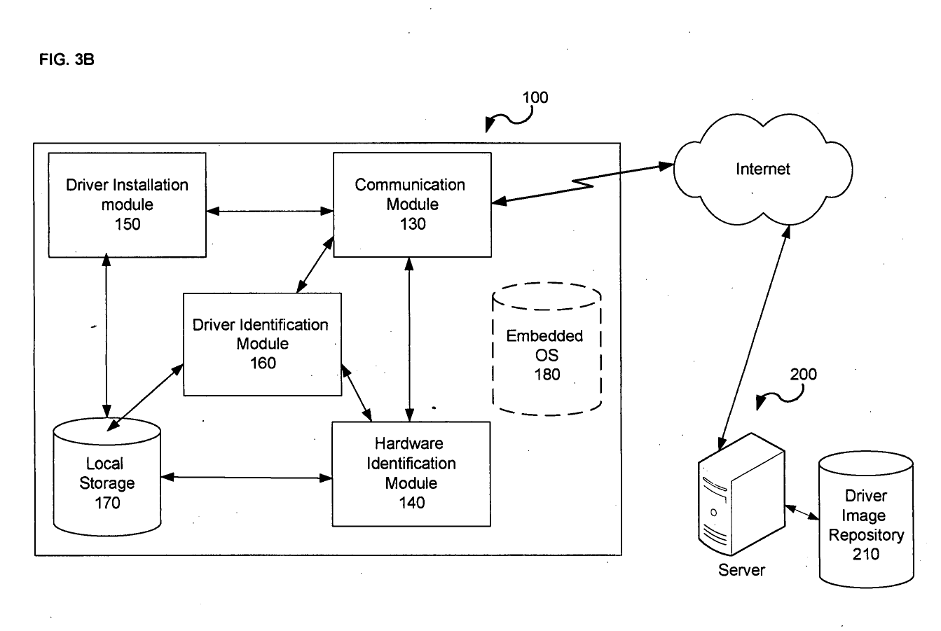

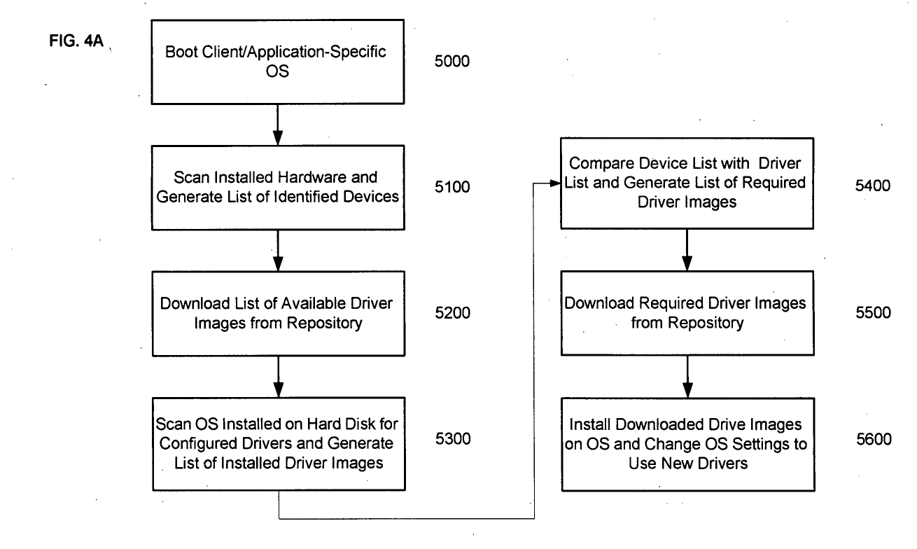

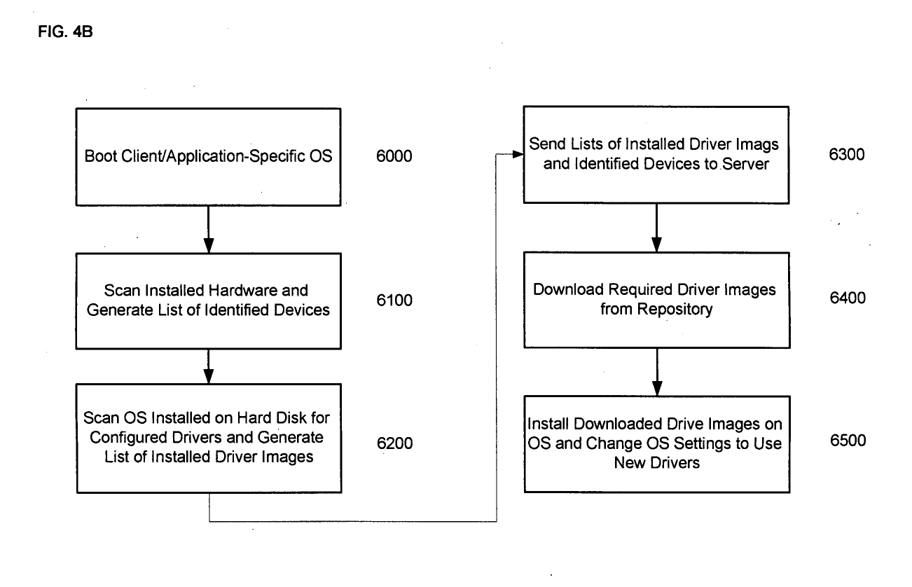

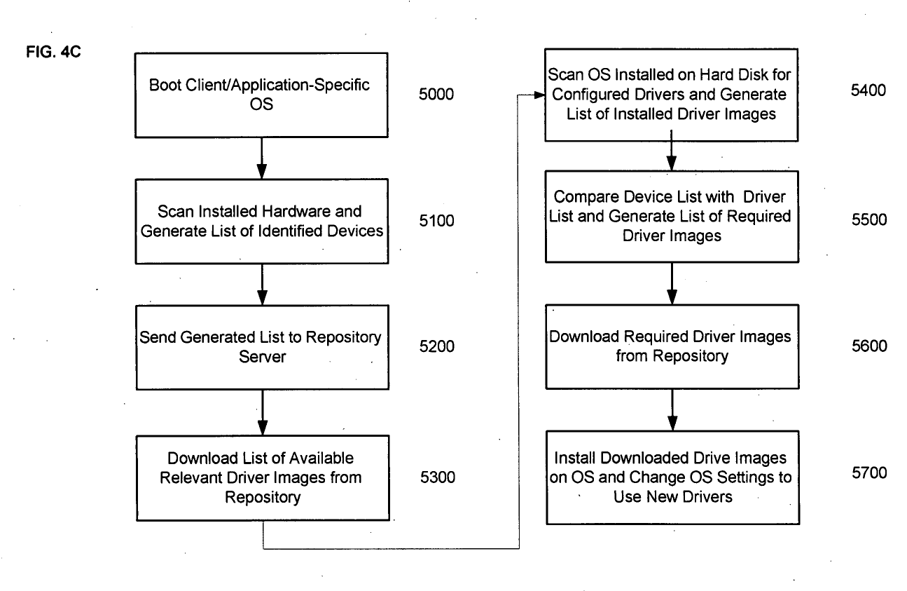

Reference is now made to FIG. 3A, which is a block diagram illustrating the functional building blocks of a computer running the driver replacement system (“client computer”) in accordance with some embodiments of the present invention, and to FIG. 4A, which is a flowchart illustrating an exemplary method by which a driver replacement system replaces drivers on a computer. According to some embodiments of the present invention, the client computer may use an operating system installed on the local hard disk 170, or an application-specific operating system 180 installed on fixed or removable storage media in order to modify and/or replace image blocks which may be protected by the operating system installed on the hard disk 170 (step 5000). The hardware identification module 140 may then scan the hardware and may generate a list of identified devices (step 5100). The client then downloads from the repository 210 a list of available driver images (step 5200). The repository 210 may be kept on a storage media associated with the client 100, or on a remote server. The driver identification module 160 then scans the operating system installed on the hard disk 170 for installed driver images (step 5300). The client then generates a list of required driver images which are available (step 5400) and gets them from the repository 210 (step 5500). The driver images are then installed by the driver installation module 150 (step 5600).

Reference is now made to FIG. 3B, which is a block diagram illustrating the functional building blocks of a driver replacement system in accordance with some embodiments of the present invention and to FIG. 4B, which is a flowchart illustrating an exemplary method by which a driver replacement system replaces drivers on a computer. According to some embodiments of the present invention, the client computer may use an operating system installed on the local hard disk 170, or an application-specific operating system 180 installed on fixed or removable storage media in order to modify and/or replace image blocks which may be protected by the operating system installed on the hard disk 170 (step 6000). The hardware identification module 140 then scans the hardware and generates a list of identified devices (step 6100). The driver identification module 160 then scans the operating system installed on the hard disk 170 for installed drivers (step 6200). The client then connects to the server 200 via the communication module 130, and sends it the lists of identified devices and installed driver images (step 6300). The client then downloads the required driver images from the server 200 (step 6400). After the driver images have been downloaded, they are installed by the driver installation module 150 (step 6500).

Reference is now made to FIG. 3A, which is a block diagram illustrating the functional building blocks of a computer running the driver replacement system (“client computer”) in accordance with some embodiments of the present invention, and to FIG. 4C, which is a flowchart illustrating an exemplary method by which a driver replacement system replaces drivers on a computer. According to some embodiments of the present invention, the client computer may use an operating system installed on the local hard disk 170, or an application-specific operating system 180 installed on fixed or removable storage media in order to modify and/or replace image blocks which may be protected by the operating system installed on the hard disk 170 (step 5000). The hardware identification module 140 may then scan the hardware and may generate a list of identified devices (step 5100). The client then sends to the server identifiers for the devices it has detected (step 5200). The client then downloads from the repository 210 a list of relevant driver images which are available in the repository (step 5300). The repository 210 may be kept on a storage media associated with the client 100, or on a remote server. The driver identification module 160 then scans the operating system installed on the hard disk 170 for installed driver images (step 5400). The client then generates a list of required driver images which are available (step 5500) and gets them from the repository 210 (step 5600). The driver images are then installed by the driver installation module 150 (step 5700).

While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

What is claimed:

1. A system for replacing device drivers comprising:
a hardware scanning module adapted to identify devices associated with the computing platform and to generate a list of device identifiers;
a comparison module adapted to compare the device identifiers in the list with device identifiers of installed drivers on an operating system associated with the computing platform; and
a driver replacement module adapted to use one or more driver image blocks from a driver image repository in order to either modify or replace an installed driver associated with a device identifier not correlated with the generated list of device identifiers.

2. The system according to claim 1, wherein the comparison module is further adapted to compare driver components which exist on a client computer with a reference list of driver components associated with the client's operating system and computing platform.

3. The system according to claim 1, further comprising an application-specific operating system adapted to load said system independently of the operating system associated to the computing platform.

4. The system according to claim 1, wherein said driver replacement module replaces a driver file.

5. The system according to claim 4, wherein said driver replacement module is further adapted to modify operating system settings.

6. The system according to claim 4, wherein replacement drivers are stored on a hard disk drive associated with the computing system.

7. The system according to claim 4, wherein replacement drivers are stored on a removable storage media not permanently associated with the computing system.

8. The system according to claim 4, wherein replacement drivers are stored on a repository server.

9. The system according to claim 1, wherein said driver replacement module replaces a driver image.

10. The system according to claim 9, wherein said driver replacement module is further adapted to modify operating system settings.

11. The system according to claim 9, wherein replacement driver images are stored on a hard disk drive associated with the computing system.

12. The system according to claim 9, wherein replacement driver images are stored on a removable storage media not permanently associated with the computing system.

13. The system according to claim 9, wherein replacement driver images are stored on a repository server.

14. A method for replacing device drivers comprising:
identifying devices associated with the computing platform and generating a list of device identifiers;
comparing device identifiers derived from images of drivers installed with an operating system associated to the computing platform; and
replacing an installed driver associated with a device identifier not correlated with the generated list of device identifiers.

15. The method according to claim 14, further comprising comparing driver components which exist on a client computer with a reference list of driver components associated with the client's operating system and computing platform.

16. The method according to claim 14, further comprising performing said method independently of the operating system associated to the computing platform.

17. The method according to claim 14, wherein driver replacement comprises replacing a driver file.

18. The method according to claim 17, wherein replacing an installed driver includes modifying operating system settings.

19. The method according to claim 17, wherein replacement drivers are loaded from a hard disk drive associated with the computing system.

20. The method according to claim 17, wherein replacement drivers are loaded from a removable storage media not permanently associated with the computing system.

21. The method according to claim 17, wherein replacement drivers are loaded from a repository server.

22. The method according to claim 14, wherein driver replacement comprises replacing a driver image.

23. The method according to claim 22, wherein replacing an installed driver includes modifying operating system settings.

24. The method according to claim 22, wherein replacement drivers are loaded from a hard disk drive associated with the computing system.

25. The method according to claim 22, wherein replacement drivers are loaded from a removable storage media not permanently associated with the computing system.

26. The method according to claim 22, wherein replacement drivers are loaded from a repository server.

27. Computer executable code stored on a digital storage medium and when executed by a processor of a computing platform said code adapted to cause the processor to:
identify devices associated with the computing platform and generating a list of device identifiers;
compare device identifiers derived from images of drivers installed with an operating system associated to the computing platform; and
replace an installed driver associated with a device identifier not correlated with the generated list of device identifiers.

28. The code according to claim 27, further comprising the ability to compare driver components which exist on a client computer with a reference list of driver components associated with the client's operating system and computing platform.

29. The code according to claim 27, further comprising the ability to execute independently of the operating system associated to the computing platform.

30. The code according to claim 27, wherein replacing an installed driver includes modifying operating system settings.

31. The code according to claim 27, wherein replacement drivers are loaded from a hard disk drive associated with the computing system.

32. The code according to claim 27, wherein replacement drivers are loaded from a removable storage media not permanently associated with the computing system.

33. The code according to claim 27, wherein replacement drivers are loaded from a repository server.
